(19) United States
(12) Patent Application Publication
(10) Pub. No.: US 2008/0130865 A1
(43) Pub. Date: Jun. 5, 2008

(54) CALL HOLD ENHANCEMENT FOR IMPROVED USER FEEDBACK

(75) Inventors: Gregory J. Boss, American Fork, UT (US); Rick Hamilton, Charlottesville, VA (US); John S. Langford, Austin, TX (US); Timothy M. Waters, Hiram, GA (US)

Correspondence Address: CANTOR COLBURN LLP - IBM AUSTIN, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/565,824

(22) Filed: Dec. 1, 2006

(51) Int. Cl. H04M 3/22

(52) U.S. Cl. 379/266.01

(57) ABSTRACT

A method for the enhancement of a call on-hold operation by the utilization of on-hold calling party feedback information, wherein the method comprises the steps of initiating a primary call from an operator of a communication device, receiving the primary call at a call center, and placing the primary call received at the call center from the communication device in a primary on-hold status state, and placing the on-hold received primary call in an incoming call queue at the call center. Further, the primary call is placed in a secondary on-hold status by the actions of the communication device in order for the communication device to receive a secondary call, the primary call's position in the call queue is maintained, and a response from the communication device is transmitted to the call center upon the call center's suspension of the on-hold status of the primary call.

### BACKGROUND OF THE INVENTION

1. Field of the Invention

This invention relates to telecommunication device services, and particularly to methods for enhancing call-hold services.

2. Description of Background

Before our invention whenever an individual placed a call to a center, there was a great likelihood that the individual's incoming call to the call center would be placed in a holding queue upon being received. This particular situation placed the caller at a disadvantage, since in order to preserve their place in the incoming call queue, the caller had to stay on the line while their call was placed on hold. In the event that the caller themselves received an incoming call, or had to step away from their telephone, the caller ran the chance that their call would be answered at the call center by a representative, the representative who upon finding that the caller is not waiting on the line would immediately terminate the call.

Therefore, there exists a need for a solution to the above-mentioned scenario, wherein the incoming call recipient upon answering a call where the caller is absent from the line is properly alerted to the status of the call as being an actively engaged call.

### SUMMARY OF THE INVENTION

The shortcomings of the prior art are overcome and additional advantages are provided through the provision of a method for the enhancement of a call on-hold operation by the utilization of on-hold calling party feedback information, wherein the method comprises the steps of initiating a primary call from an operator of a communication device, receiving the primary call at a call center, and placing the primary call received at the call center from the communication device in a primary on-hold status state by actions at the call center, wherein the on-hold status of the received primary call further comprises placing the on-hold received primary call in an incoming call queue at the call center.

Further, the method comprises the steps of placing the primary call in a secondary on-hold status by the actions of the communication device, maintaining the primary call's position in the call queue, and transmitting a response from the communication device to the call center upon the call center's suspension of the on-hold status of the primary call.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a flow diagram detailing one example of the present invention.

FIG. 2 illustrates a flow diagram detailing one example of the present invention that is implemented by means of call center.

FIG. 3 illustrates a flow diagram detailing one example of the present invention that is implemented by means of a communication device possessed by a call initiator.

FIG. 4 illustrates a flow diagram detailing one example of the present invention that is implemented by the means of a public telephone exchange.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art. In reference to the drawings, like numbers will indicate like parts continuously throughout the views.

As mentioned above, aspects of the present invention relate to the enhancement of call hold status operations for the initiator of an outgoing telephone call to a call center of a respective company. For example, typically when a caller places a telephone call to a customer service or support center, the call is placed in a call hold queue to wait to be answered by a call center representative. In the event that the caller either receives an incoming second call, or has to step away from the phone for an indeterminable amount of time, the caller runs the risk of not being on the line when the call center representative picks up the call. Upon answering the incoming call and finding no party on the other end of the line, the call center representative will typically terminate the call. This action results in the caller's needs not being properly serviced, and the call center of the company losing the opportunity to build a contented customer base.

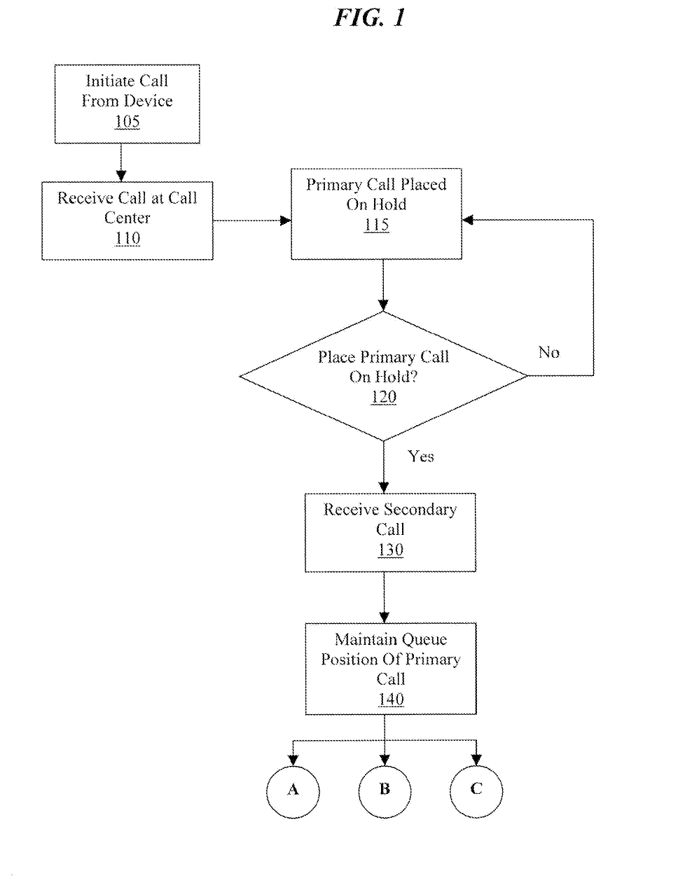

Turning now to the drawings in greater detail, it will be seen that in FIG. 1 there is flow chart detailing a method for the enhancement of a call on-hold operation by the utilization of on-hold calling party feedback information. At step 105, a primary call from an operator of a communication device (e.g., telephone connected by a land line, cell phone, etc . . . ), thereinafter the call is received at call center incoming call distribution center (step 110). As a function of the call center's call support protocol, the incoming call is placed on hold (step 115), and assigned to an incoming call queue to await being answered by a call center representative.

At step 120, the caller is presented with the dilemma of having to leave the primary call that is on hold in order to attend to another matter (e.g., to answer a secondary incoming call, or to temporarily step away from the communication device). If the caller takes no action to leave the call, then they will continue to wait in the current hold-status of the call. If the caller must leave the call to attend to another matter (step 130), the caller's position in the incoming call queue will be maintained (step 140).

Further aspects of the present invention allow for the enhanced call-holding feature of the present invention to be implemented via the incoming call operational control software at a call center, by functional operations that are initiated at the caller's device, or by functional operations that are initiated at a switch within a telephone company's telephone exchange station.

For example, the functional aspects of the present invention as embodied at a call center can be accomplished by the use of incoming call queue management software that offers a series of call response options to a waiting caller. Such options can include a call callback feature, wherein a caller could request that they receive a response call from the call center at a future date and time. Also, the options can include the preference that a waiting caller temporarily are allowed to suspend their waiting period for a predetermined amount of time—while still maintaining the caller's position in the incoming call queue. More specifically, depending on the call center's configurable call queuing policy, the caller will be presented by voice response unit with the option of requesting a fixed number of minutes, or seconds to return to the call before the call is disconnected. Alternatively, a caller can be presented with the option of reporting to the system the length of time that the caller expects to be away from the call. In either scenario, the caller's position in the incoming call queue will be maintained, and the call would not be answered in this period. When the caller returns to the call, the caller either speaks a voice command, or press a key on the communication device signaling that the caller is back and wishes to have the hold-status of the call rescinded, and thus placing the call back in the active incoming call queue.

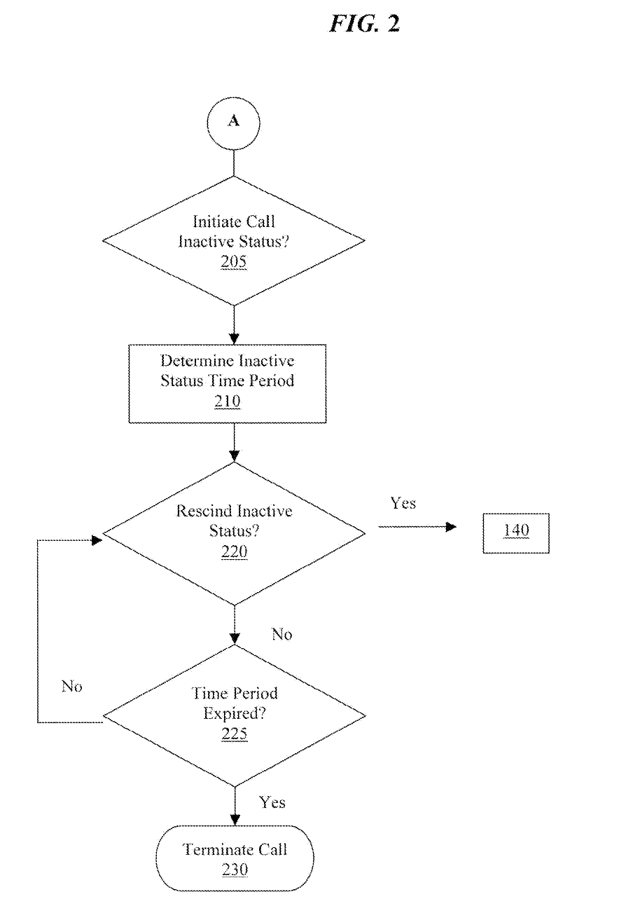

Aspects of this presently explained embodiment are detailed in FIG. 2. At step 205, a primary call from a caller to the call center is placed in a secondary on-hold status. At step 210, a call center communication interface communicates to the communication device operator the option of the operator temporarily placing the on-hold primary call in an inactive secondary hold status, wherein the on-hold status of the primary call would not be suspended, and the primary call's position in the call queue would be maintained. At step 210, the operator is presented with the option of configuring the inactive status of the on-hold primary call to be maintained for a predetermined period of time.

The system will periodically check to see if an inactive hold-call's inactive status has been rescinded (220). If the communication device operator communicates to the call center interface that inactive status of the on-hold primary call is rescinded, the on-hold primary call is actively placed back within the call queue (step 140). In the event that the communication device operator does not desire to end the inactive call time period status of the call, then at step 225 a determination is made as to whether the requested inactive call status time period of the call has expired. If the communication device operator does not initiate communication with the call center communication interface within the predetermined period of time, the on-hold call is disconnected (230).

Another aspect for accomplishing the functional operations of the present invention relate to the configuring of a communication device to comprise the function of replaying either a prerecorded, or custom recorded message to a called party on the line informing the called party of the imminent return of the communication device operator to the call, the message further beseeching the called party to stay on the line. For instance, a device could be configured with an optional message feature key, or a preexisting key on the device could be programmed to perform the described operation upon initiation of the key.

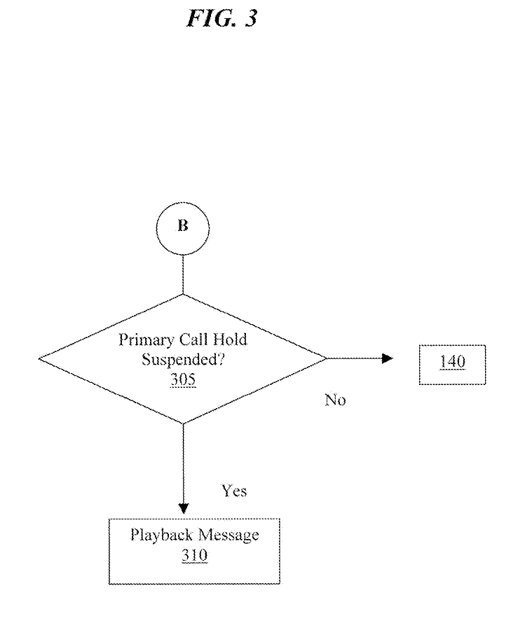

For example, a caller is waiting online in an incoming call queue of a call center. Unexpectedly, the caller is called away from the line (to either answer an incoming call, or to step away from the calling device). In this instance, the caller can activate the message playback operation of the communication device by pressing the appropriate key on the communication device. Upon activation, the communication device plays back either a prerecorded message, or a custom recorded message, on the open line. The message will be repeated until the operation is deactivated, thus ensuring that the party on the other end of the line will hear the caller's request to stay on the line. This aspect of the present invention is shown in FIG. 3, wherein at step 305 a determination is made by the caller to either stay on hold on a line, or place the primary call in a secondary on-hold status. If the caller takes no action, then the caller will continue to be maintained in the incoming call queue of the call center (step 140). If the caller decides to suspend the current call, the message playback feature is activated, and the playback message is replayed until deactivated by the communication device operator.

A yet another aspect for accomplishing the functional operations of the present invention relate to configuring a telephone exchange station of telephone company to perform enhanced call monitoring operations. For example, a telephone company could offer an enhanced variant call waiting service to customers. The enhanced service provides to a caller on a primary line that is on hold the option of answering a second incoming call on a second line by way of a conventional call waiting operation. By entering a predetermined key sequence at the communication device, the enhanced call waiting service can be activated by the communication device operator. However, the enhanced operation is further configured to monitor the primary call line for any significant transmission of sound (i.e., based upon predetermined sound levels) on the primary line. Upon the detection of a significant amount of sound on the primary line, the telephone exchange can be configured to automatically switch the caller from the secondary calling line to the primary calling line, thus placing the secondary call on hold. The parties that are on the secondary line will be notified by a prerecorded message that the their call line has been temporarily been put on hold.

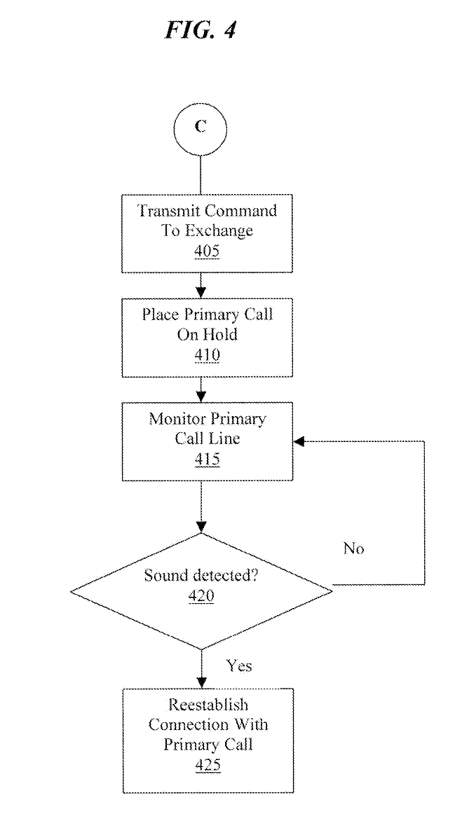

As shown in FIG. 4, at step 405 the communication device operator activates the enhanced call waiting function at a telephone exchange by transmitting a command to a telephone exchange via the communication device. At step 410, a primary call of the caller is placed on hold, thereafter, at step 415 the telephone exchange monitors the caller's on-hold primary calls. At step 420 a determination is made if the sounds detected on the line (e.g., the voice of a call center representative establishing communication on the calling line) are measured above predetermined sound levels. If the determination is made that the sound levels on the line are above predetermined levels, then the connection of the primary call to the communication device is automatically reestablished (step 425).

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed:

1. A method for the enhancement of a call on-hold operation by the utilization of on-hold calling party feedback information, wherein the method comprises the steps of:
initiating a primary call from an operator of a communication device;
receiving the primary call at a call center;
placing the primary call received at the call center from the communication device in a primary on-hold status state by actions at the call center, wherein the on-hold status of the received primary call further comprises placing the on-hold received primary call in an incoming call queue at the call center;
placing the primary call in a secondary on-hold status by the actions of the communication device;
maintaining the primary call's position in the call queue;
transmitting a response from the communication device to the call center upon the call center's suspension of the on-hold status of the primary call.

2. The method of claim 1, wherein the step of placing the primary call in a secondary on-hold status by the actions of the communication device further comprises the step of a call center communication interface communicating to the operator of the communication device the option of the communication device operator temporarily placing the on-hold primary call in an inactive status, wherein the on-hold status of the primary call would not be suspended and the primary call's position in the call queue would be maintained.

3. The method of claim 2, wherein the communication device operator can configure the inactive status of the on-hold primary call to be maintained for a predetermined period of time.

4. The method of claim 3, whereupon the communication device operator's communicating to the communication interface that inactive status of the on-hold primary call is rescinded, the on-hold primary call is actively placed back within the call queue.

5. The method of claim 4, wherein if the communication device operator does not initiate communication with the communication interface within the predetermined period of time, the on-hold primary call is disconnected.

6. The method of claim 1, wherein the step of transmitting a response from the communication device operator to the call center upon the call center's suspension of the on-hold status of the primary call further comprises the step of the communication device operator communicating a message to the call center.

7. The method of claim 6, wherein the message comprises an audio playback recording.

8. The method of claim 1, wherein the step of placing the primary call in a secondary on-hold status by the actions of the communication device operator is accomplished by the communication device operator's responding to a voice response unit command.

9. The method of claim 8, wherein the primary call is placed in an inactive status for a predetermined period of time.

10. The method of claim 9, wherein the communication device operator must transmit a response to the voice response unit to remove the on-hold primary call from the inactive status.

11. The method of claim 1, wherein the step of placing the primary call in a secondary on-hold status by the actions of the communication device comprises the step of the communication device operator transmitting a command to a telephone exchange via the communication device.

12. The method of claim 11, wherein the telephone exchange monitors the on-hold primary call to the call center.

13. The method of claim 12, further comprising the step of automatically reestablishing the connection of the primary call to the communication device upon the telephone exchange's detection of a predetermined level of sound coming from the call center.

14. The method of claim 13, further comprising the step of the telephone exchange automatically placing the secondary call into an on-hold status upon the telephone exchange's detection of a predetermined level of sound coming from the call center.
